(19) United States
(12) Patent Application Publication
(10) Pub. No.: US 2008/0211768 A1
(43) Pub. Date: Sep. 4, 2008

(54) Inertial Sensor Input Device

(76) Inventors: Randy Breen, Mill Valley, CA (US); Vadim Gerasimov, Epping (AU)

Correspondence Address: FISH & RICHARDSON P.C., PO BOX 1022, MINNEAPOLIS, MN, 55440-1022, US

(21) Appl. No.: 11/950,309

(22) Filed: Dec. 4, 2007

Related U.S. Application Data
(60) Provisional application No. 60/869,104, filed on Dec. 7, 2006.

(51) Int. Cl. G06F 3/033

(52) U.S. Cl. 345/157

(57) ABSTRACT

Head motion input devices for providing control to a computer are described.

### CROSS-REFERENCE TO RELATED APPLICATIONS

This application claims priority to U.S. Provisional Application Ser. No. 60/869,104, filed on Dec. 7, 2006. The disclosure of the prior application is considered part of and is incorporated by reference in the disclosure of this application.

### BACKGROUND

This invention relates to an input device for an electronic system.

Many input devices have been invented for a user to interact and provide instructions to computer applications. Some of these devices include mice, touchpads, trackballs, trackpoints, joysticks, touchscreens, and digitizers. Different styles of input devices appeal to different people. For example, a broad range of mice are available, each with features that provide different ergonomics, type of inputs or ease of use.

The input devices presently available can be categorized into three categories: mouse-like, joystick-like and digitizer-like devices. Each has different benefits and limitations.

Mouse-like devices are often used in a “move-shift-move” pattern. For example, in the case of a mouse, the mouse is moved to change the cursor position, shifted by lifting the mouse off the surface, repositioning, and putting the device at a new location and then moved again to change the cursor position again. The device does not move the cursor during the shifting procedure. Such shifting effectively extends the coordinate range of the mouse beyond the mouse pad or hand-movement space. This allows the user to have both fine cursor positioning and long-range motion within a limited desk (mouse pad) space. The mouse is a relative positioning device, because the cursor position on the screen is moved relative to the previous position of the input device. Similarly, touchpads and trackballs are relative and have corresponding shift actions to avoid range limitations. The “move-shift-move” pattern is a learned behavior that often takes users some amount of time to adapt to.

Joystick-like devices, including trackpoints, are quite different in their user interaction pattern. These devices usually control velocity rather than position of the cursor or other object on the screen. The amount of deflection from the center of the joystick or force applied to the trackpoint button controls the first derivative of the computer coordinates. As opposed to the mouse-like devices, the user can cover the whole coordinate space without ever releasing the control stick of the device. Such devices require precise calibration of the central position that corresponds to no movement of the computer element, that is, the cursor. To avoid some calibration problems and drifts, joystick-like devices may have a so-called dead zone: a range of deflection of force around the central point that results in no motion of the controlled element.

Digitizer-like devices include digitizers, electronic pen and pad devices and touch screens. Such devices can provide input to a device that presents little else for a user than a screen for the user to interact with.

### SUMMARY

In one aspect an input device is described that includes a headset configured to be worn on a user's head, a sensor secured by the headset and a processing component in electrical communication with the sensor. The sensor is configured to determine a movement of the headset. The processing component is configured to suppress a portion of the signals received from the sensor, wherein suppression is based on a speed, direction or distance of movement of the headset. The sensor or processing component is configured to produce position information for controlling a computer element.

In another aspect an input device is described that includes a headset configured to be worn on a user's head, a sensor secured by the headset and a processing component in electrical communication with the sensor. The sensor is configured to determine a movement of the headset. The processing component is configured to transform the movement of the headset into input for a computer which indicate a change in camera angle, wherein greater movement corresponds to a faster change in camera angle and lesser movement corresponds to a slower change in camera angle.

In yet another aspect an input device is described that includes a headset configured to be worn on a user's head, a state sensor secured by the headset, a biometric sensor secured by the headset and a processing component in electrical communication with the sensor. The state sensor is configured to determine a movement of the headset. The biometric sensor is configured to determine electric activity from the user's head. The processing component is in electrical communication with the state sensor and the biometric sensor. The processing component is configured to create an input signal for a computing device from signals received from the state sensor and the biometric sensor.

In another aspect, a computer program product, encoded on a computer-readable medium, operable to cause a data processing apparatus to perform operations is described. The product causes the following steps: receiving a signal from a sensor, where the signal corresponds to movement of a user's head on which the sensor is located; suppressing a portion of the signal from the sensor to create a modified signal, wherein the suppressing is based on a speed, direction or distance of movement of the user's head as indicated by the signal; transforming the signal to input for a computer, wherein the input includes position information for controlling a computer element; and sending the input to a computer.

In yet another aspect, a computer program product, encoded on a computer-readable medium, operable to cause a data processing apparatus to perform operations is described. The product causes the following steps: receiving a signal from a sensor, where the signal corresponds to movement of a user's head on which the sensor is located; suppressing a portion of the signal from the sensor to create a modified signal, wherein the suppressing is based on a speed, direction or distance of movement of the user's head as indicated by the signal; transforming the signal to input for a computer, wherein the input includes position information for controlling a computer element; and sending the input to a computer.

In another aspect, a computer program product, encoded on a computer-readable medium, operable to cause a data processing apparatus to perform operations is described. The product causes the following steps: receiving input from a head motion input device, wherein the input corresponds to motion or orientation detected by a gyroscope, a magnetometer or a combination thereof, corresponding the input to instructions to move a computer element a distance; selecting an anchor point in a grid; at a predetermined time, determining whether the distance is above or below a threshold; and if the distance is below the threshold, not moving the computer element and if the distance is above the threshold, moving the computer element the distance.

In yet another aspect, a computer program product, encoded on a computer-readable medium, operable to cause a data processing apparatus to perform operations is described. The product causes the following steps: receiving a signal from a sensor, where the signal corresponds to movement or orientation of a user's head on which the sensor is located; suppressing a portion of the signal from the sensor to create a modified signal, wherein the suppressing is based on a speed, direction or distance of movement of the user's head as indicated by the signal; transforming the signal to input for a computer; and sending the input to a computer.

In another aspect, a computer program product, encoded on a computer-readable medium, operable to cause a data processing apparatus to perform operations is described. The product causes the following steps: receiving a state signal from a state sensor, where the signal corresponds to movement or orientation of a user's head on which the state sensor is located; receiving a biometric signal from a biometric sensor, wherein the biometric sensor is configured to determine electric activity from the user's head; transforming the state signal and biometric signal to input for a computer; and sending the input to a computer.

In yet another aspect, a computer program product, encoded on a computer-readable medium, operable to cause a data processing apparatus to perform operations is described. The product causes the following steps: receiving a signal from a sensor, where the signal corresponds to movement of a user's head on which the sensor is located; transforming the signal to input for a computer, wherein the input includes camera angle information for controlling a computer element, wherein greater movement corresponds to faster camera angle change and lesser movement corresponds to slower camera angle change; and sending the input to a computer.

Embodiments of the systems and products described herein may include one or more of the following features. The processing component can be configured to suppress a portion of the signals when the signals indicate the user's head is moving in a reverse motion following a faster forward motion. The processing component can be configured to suppress a portion of the signals when the signals indicate the user's head is moving faster than a threshold velocity. The processing component can be configured to suppress a portion of the signals when the signals indicate that the user's head has moved less than a predefined threshold. The sensor can include a gyroscope and a transmitter can be in communication with the processing component and secured by the headset. The device can include a second gyroscope in communication with the transmitter and secured by the headset. The processing component can be configured to provide signals for inputting to a computer that is remote from the input device. The sensor can be a gyroscope and the device can further comprise an accelerometer secured by the headset and in communication with the processing component. The device can further include a magnetometer secured by the headset. The processing component can be further configured to use the signal received from the accelerometer and a signal received from the magnetometer to modify a signal generated by the processing component. The processing component can be configured to remove integration error propagated by the gyroscope. The device can include a microphone secured by the headset and a transmitter configured to transmit signals generated by the microphone and the sensor. The device can include a bioelectric sensor and a transmitter configured to transmit signals generated by the bioelectric sensor and the sensor. Position changes can be determined with respect to a coordinate system of the headset.

Embodiments of the systems and products described herein may include one or more of the following features. Operations caused by the product can include determining whether the user's head moves faster than a threshold velocity and suppressing a portion of the signal includes suppressing a portion of the signal received from the sensor after the fast head motion. The suppressed signal can have a duration of less than about a half second. Operations caused by the product can include determining whether the user's head moves faster than a threshold velocity and suppressing a portion of the signal includes suppressing the signal received from the gyroscope that is in reverse of movement faster than the threshold velocity. Operations caused by the product can include determining whether the user's head moves beyond a threshold distance within a predetermined time period and suppressing a portion of the signal includes suppressing the signal received from the gyroscope if movement is not beyond the threshold distance. Operations caused by the product can include receiving an audio signal, corresponding the audio signal with an instruction to move a computer element to create an audio based input and sending the audio based input to the computer along with the sensor based input. Operations caused by the product can include receiving a bioelectric signal, transforming the bioelectric signal to a bioelectric based input for a computer and sending the bioelectric based input to the computer along with the sensor based input. Operations caused by the product can include receiving a correction signal from an accelerometer or a magnetometer and before sending the input, correcting error in the signal from the sensor with the correction signal. The error can be integration error. Operations caused by the product can include receiving a signal from a magnetometer, and transforming the signal from the magnetometer to second input for a computer and sending the second input to the computer. The first input and the second input can be combined into a single input signal. Operations caused by the product can include receiving a signal from an accelerometer, transforming the signal from the accelerometer to second input for a computer and sending the second input to the computer. If the computer element is moved, the product is further operable to cause a data processing apparatus to perform operations, comprising selecting a new anchor point that is at a grid point closest to an absolute position corresponding to the instruction.

Advantages of the methods and systems described herein can include one or more of the following. A head motion input device can provide a convenient hands-free way of providing positional data input to a computing device. This can free a user's hands to provide other types of input, or can free the user from having to use his or her hands altogether. For example, the head motion input device may be used to control a cursor on a screen or a viewing angle of a “camera”, i.e., a perspective view, e.g., a first person perspective, in a game or application. A user with a head motion input device can move his or her head in a way that moves the cursor or camera, allowing the user to input some other instructions, such as, shooting a gun, focusing a lens, moving a player within a game, or other such action, with manual input. Because with a head motion input device multiple inputs can be provided simultaneously, more complex instructions can be presented to the application, which in turn can provide for a multifaceted and richer experience for the user when interacting with the application. In addition to providing a different method for inputting instructions, the head motion input device may function in a way that is more intuitive or more natural for the user than other input devices, such as joysticks, mice or buttons. Because the device can be rather intuitive to use, there can be a very short learning curve for the user. A short learning curve may increase the user's interest in the device and in the application being used with the device. When a user can spend more time with the application and less time learning how to interact with the application, the user satisfaction with the input device, the software and the system as a whole may be greater. In addition, the devices described herein do not require an external component for input. That is, unlike input devices that track head movement using components that sit in a location other than the user's head, the devices described herein may be entirely contained a device donned by the user. Also, an external referencing device is not required by the devices described herein.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 shows a schematic of a user with a headset device having a head motion input device.

FIGS. 2 and 3 are schematics of head motion input devices.

FIGS. 4 and 5 show GUIs for input control.

FIG. 6 shows an exemplary system with a device attached to a headset.

FIG. 7 shows a schematic of the gyroscope connection.

FIG. 8 shows an exemplary system with bioelectric sensors and a movement device.

Like reference symbols in the various drawings indicate like elements.

### DETAILED DESCRIPTION

The systems described herein measure and track the movement of a headset when worn by a user to control an aspect of a computer application, such as a mouse cursor or a camera. As used herein, “movement” includes one or more of angular orientation, angular velocity or angular acceleration. The movement is then transformed or mapped into information that determines how the aspect of the computer application should be controlled. For example, the movement can be translated into mouse cursor movement and the information is positional information. Alternatively, the movement can be used to change a camera angle. In some embodiments, the movement is measured and sent to the computer in real time, and there is no delay. Thus, the system can provide head motion information while the headset is moving. Further, the rotational velocity can be used to control the mouse cursor to a new set of coordinates within a view, e.g., a frame, shown on a screen, rather than move the view shown on a screen to a new viewing location or a new frame within the overall image, document or application.

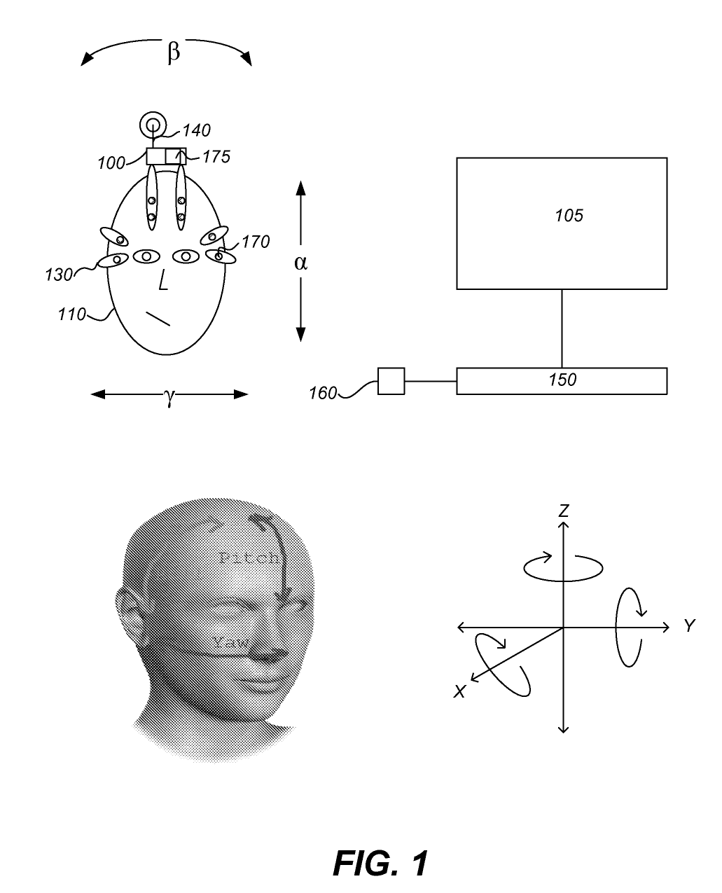

The ability to control an element in a graphical user interface, such as a cursor, or a viewing angle of a camera, is typically achieved with an input device, such as a mouse, a joystick, a touch pad, a trackpoint button, a controller or other suitable device. Exchanging one of the aforementioned input devices with an input device that translates the user's head motion into input for the computer element can provide the user with a hands-free, and possibly more intuitive, method of control. Referring to FIG. 1, such an input device 100, which translates a user's head movements into computer input and is worn on the user's head, is described herein and includes any combination of gyroscopes, accelerometers, magnetometers and tilt sensors.

When viewing a stationary screen 105, such as a television or computer monitor, the user is more likely to rotate than to translate his or her head 110. In some embodiments, the screen 105 is remote from the user's head. In some embodiments, the screen 105 is stationary with respect to any movements that the user makes. Most head motion with respect to the body can be expressed in terms of three angles with respect to three coordinate axes. The most natural way to express head position or orientation is in terms of pitch α, roll β, and yaw γ angles. The human vestibular system has horizontal, anterior and posterior semicircular canals that are extremely sensitive to pitch, roll, and yaw rotation of the head. This explains why humans are able to detect and have fine control of their head rotation. Similarly, the head is able to determine the perceived rotational coordinate system.

The input device 100 can be held by a headset 130, which secures the device 100 to the user's head 110. The device 100 or the headset 130 can include a state sensor 175, which can determine orientation or movement, and a wireless transmitter 140, such as a radio transmitter, or other type of device for sending signals from the device 100 to a computer 150. In lieu of a wireless transmitter 140, a hardwired cable can be used for the device 100 and computer 150 to communicate. The computer 150 can be any type of computing device, such as a personal computer or a gaming console. The computer 150 is in communication with the screen 105. In addition, the computer 150 is either in communication with or includes a receiver 160 for receiving signals from the transmitter 140. The state sensor 175 can include one or more of a gyroscope, accelerometer, magnetometer, tilt sensor or any combination thereof. In addition to holding the input device 100 in place, the headset 130 can also include electrodes 170, which can detect muscle movement or electrical activity of the brain. Each of these signals can be communicated to the computer 150 to provide input along with the signals from the input device 100. The headset 130 and sensors 170 are described further in U.S. Publication No. 2007-0225585, which published on Mar. 21, 2007, and is incorporated herein by reference.

In most applications pitch, roll, and yaw are measured with respect to the external coordinate system, that is, as if the object is sequentially rotated around Y, X, and Z coordinate axes. For head motion, however, a more natural way of determining the pitch, roll, and yaw angles is to measure rotation angles with respect to the head coordinate system. For pitch, the rotation is the same as in the usual case, around the Y axis. But roll and yaw are measured with respect to the head's vertical and horizontal axes, which can be different from the external X and Z axes. The device can be calibrated to determine the location of the axes with respect to the user, as described further herein. Thus, the position changes are determined in relationship to the headset, or the user's head, because the user's head is set as the basis of the coordinate system. Any movement from the headset is then transformed into mouse or cursor control signals along x, y and z axes. For example, headset pitch change may be translated into movement of the cursor along the y axis of a screen and headset yaw may be translated into movement of the cursor along the x axis of the screen. Because the headset determines the coordinate system, even if the headset is askew on the user's head or if the user's head is tilted at an angle, the positional change of the cursor can be determined and not distorted by the tilt of the user's head or the headset.

Gyroscopes, also referred to as angular rate sensors, measure angular rotation rate, also called rotational velocity, rather than sensing the absolute orientation directly. It is possible to integrate the measured velocity to obtain the absolute angle. Gyroscopes work well for fine movement detection. Thus, they can be used to determine pitch and roll of the user's head.

Accelerometers and tilt sensors are also capable of detecting the pitch and roll of the object, with respect to the earth's gravity. A 3-axis accelerometer outputs three coordinates of the measured inertial vector, which is a sum of an object's acceleration vector and the vector opposite the gravity vector. Assuming the acceleration vector is significantly smaller than g, 9.8 m/s², the accelerometer output can be interpreted as minus the gravity vector, i.e., an upward acceleration vector of magnitude g, 9.8 m/s². The deviation of the gravity vector from the vertical position is translated into corresponding pitch and roll angles. Tilt sensors usually output non-linear values that correspond to pitch and roll angles and can be used to calculate the angles. Tilt sensors are also sensitive to acceleration.

Accelerometers and tilt sensors cannot however, provide the absolute yaw position with respect to gravity. To determine the yaw position, magnetometers can be used. A 3-axis magnetometer outputs a measured magnetic vector. The magnetic vector is generally not parallel to the ground, for example, in some locations, such as in parts of Sydney, Australia, the magnetic vector has a vertical component roughly twice as large as the horizontal one. In locations closer to the equator, the magnetic vector is closer to parallel with the ground. The magnetic vector alone cannot provide the system with complete orientation information. Similar to the yaw rotation with respect to gravity, a rotation around the magnetic vector cannot be detected and measured by the magnetic sensors.

In addition to some of the components not being able to provide complete data in terms of pitch, roll and yaw on their own, using one or more of these components in a head input device can present difficulties that may require solutions in certain software or hardware environments. For example, a user's head will make tiny adjustments that are not meant to be input instructions. Signals received from the devices, such as the gyroscope, can be set to zero when the user's head moves a small amount, such as less than some threshold amount. This can compensate for the user's small and inadvertent head movements. Further, many gyroscopes tend to be imprecise and have some inherent level of noise. Using a gyroscope to determine the pitch or roll of the user's head, such as by integrating the head's velocity to obtain the absolute angle, can result in accumulation of error which manifests as eventual deviation of the integral from the true value, which can be referred to as integration drift. The error is not stable over time and can deviate in different directions. Thus, if the input is used to control a cursor on the screen, the cursor may end up significantly off the center of vision or the desired position.

Gyroscopes are not the only components that are prone to problems when used in head motion input device. Assuming the magnetic and gravity vectors are not collinear, the vector pair can be used to determine all three angles of the absolute driftless orientation with respect to the initial position of the head. However, a problem with accelerometers and magnetometers can be low precision of their measurements. The noise from both an accelerometer and a magnetometer produces an unsteady output with plus or minus a few degrees precision. Many accelerometers and magnetometers produce an unsteady output with about ±3° of accuracy and a noise level of about 5% of the signal. Such output may not be sufficient when a head motion input device is used to control particular computer elements, such as when used for fine cursor control. Additionally, magnetometers are affected by events in the environment, such as electromagnetic disturbances from electrical equipment. Accelerometers detect the device acceleration that affects the precision of the gravity vector measurement. These can also result in inaccuracy of output of the device.

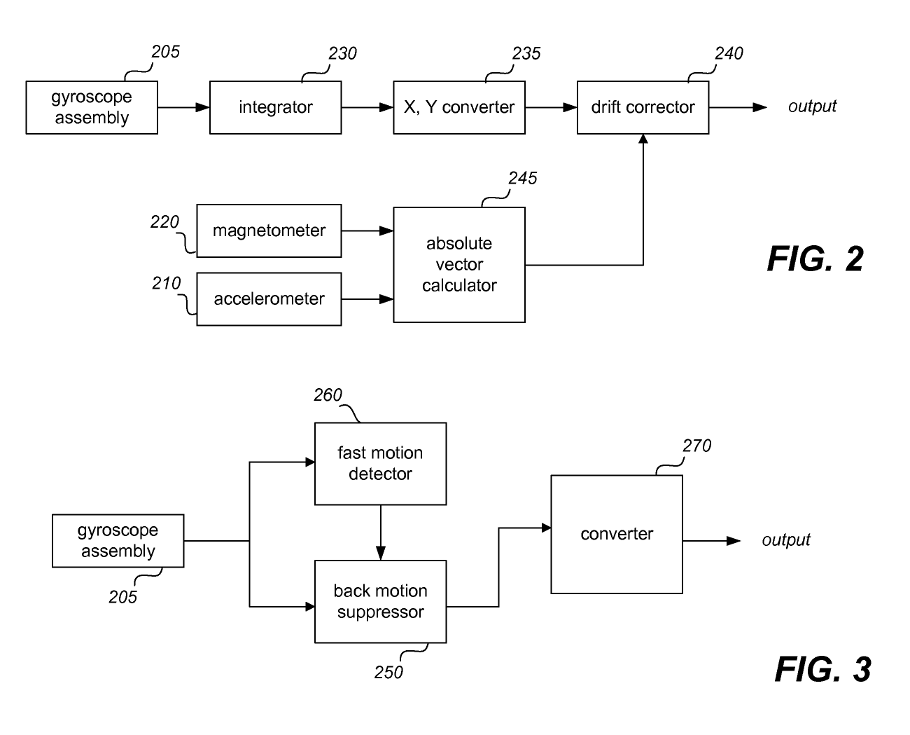

To address the potential problem related to integration drift, one or two auxiliary components can be used to adjust and to correct for the input of a primary component. Referring to FIG. 2, in some head motion input devices, a gyroscope 205 is used to determine the pitch and roll of the user's head. The accelerometer 210 and the magnetometer 220 can be used to correct the error that is introduced into the integrated velocity.

A calibration algorithm determines the user's initial absolute head orientation from the gravity and magnetic vectors. An accelerometer 210 can be used to determine the gravity at the user's location. A magnetometer 220 can be used to determine the user's magnetic vector at calibration. The pitch α, roll β, and yaw γ position of the head can then be calculated from the gravity and magnetic vectors. g̅₀ is the gravity vector measured during calibration period; m̅₀ is the magnetic vector at calibration; or ĝ₀ and \hat{m}₀ in normalized form. Pitch and roll are calculated with respect to the gravity vector and it is assumed that the head has 0 pitch; 0 roll; and 0 yaw position during the calibration. Because the head motion input device may not be perfectly aligned on the user's head in relation to the ground, the ĝ₀ value is used to move all vectors to a coordinate system where the Z axis is vertical. To cause the Z axis to be vertical, the pitch α and roll β angles of the sensor coordinate system are calculated as

α₀=arc cos(ĝ₀ₓ)−π/2

and

β₀=arc tan(−ĝ_{0y}/ĝ_{0z})+π.

The angles are used to calculate a 4×4 transform matrix M₀ that rotates the coordinate system to align the calibration gravity vector with the Z axis. The matrix is then used to transform the measured magnetic and gravity vectors into the new coordinate system.

If ĝₜ and \hat{m}ₜ are normalized gravity and magnetic vectors at time t, then the corresponding pitch αₜ and roll βₜ angles are calculated as

αₜ=arc cos(Mₒĝₜ)ₓ−π/2

and

βₜ=arc tan(−(Mₒĝₜ)_{y}/(M₀ĝₜ)_{z})+π.

The angles are used to calculate a 4×4 transform matrix Mₜ that aligns the M₀ĝₜ vector with the Z axis. The yaw angle is calculated as an angle between transformed cross products

c₀=M₀(ĝ₀×\hat{m}₀) and cₜ=MₜM₀(ĝₜ×\hat{m}ₜ).

cₒ and cₜ are vectors orthogonal to both the gravity and magnetic vectors in two coordinate systems. In the absence of magnetic and gravitational disturbances, these vectors are parallel to the ground and point to either magnetic East or West depending on the choice of the coordinate axes. Finally, the yaw angle γₜ can be calculated as the angle between cₒ and cₜ, effectively determining the change in the East or West direction with respect to the device:

γₜ=arc tan(c_{0y}/c₀ₓ)−arc tan(c_{ty}/cₜₓ).

The output of these algorithms can be used to correct gyroscope drift.

In some devices, a coarse coordinate grid is also used to keep track of the absolute position of the user's head. Measures may be taken to ensure that small inaccuracies produced by the components or small deviations of the user's head are not interpreted as undesired input. A slow anti-drift bias can be applied to the output to move the element being controlled towards the current absolute position. That is, if a mouse cursor is being controlled, the bias is applied to the output to move the cursor towards the current absolute position.

After the rotational velocity is measured by the gyroscope 205, an integrator 230 can integrate the velocity to determine a change of the head position. An X, Y converter 235 converts the change of head position to mouse-like input in a form of the absolute mouse cursor coordinates, which can be understood by a computer. A drift corrector 240 uses measurements, such as the grid algorithm described herein or an absolute vector calculated by an absolute vector calculator 245 determined by or derived from the magnetometer 220 and accelerometer 210. Alternatively, the drift corrector may occur prior to the conversion in converter 235. An output from the components can be transmitted to the computer for controlling the computer element. The converter 235, integrator 230 and drift corrector 240, and absolute vector calculator 245 can be separate processing components or in a single processing component. The drift correction component 240 can use one or more of the algorithms described herein.

The grid algorithm can determine the location of an anchor point and then determine whether the cursor should be moved closer to the anchor point to compensate for drift. The anchor point location, and whether the anchor point needs to be moved, is determined as follows. A grid algorithm uses a grid with a predefined step (e.g., 50 screen pixels). One of the grid points is defined as an anchor point to adjust the cursor position. The anchor point at time step t is selected in the following way. If the previous anchor point (at time t−1) is less than 2 grid steps (e.g., 100 screen pixels) away from the absolute position measured by the accelerometer/magnetometer or pitch/yaw algorithm, then the anchor point remains the same. If the previous anchor point is more than 2 grid steps away, then the new anchor point is the grid point closest to the absolute position from the pitch/yaw algorithm.

Calculations and system state updates are performed at discrete time steps called update time steps. The time steps are usually uniform and are an integer number of the sensor sampling time steps. A typical recommended sensor sampling rate is 100 times per second or more, which corresponds to the update time steps of 10 milliseconds or less.

The following exemplary code fragment illustrates how the anchor point may be updated (Mag is 2D vector magnitude, Sub is vector subtraction, AnchorPoint is the anchor point position, and Position is the imprecise absolute position calculated for the sensors):

if Mag(Sub(AnchorPoint, Position)) > 2*GridStep then
begin
AnchorPoint.x:=Round(Position.x) div GridStep * GridStep;
AnchorPoint.y:=Round(Position.y) div GridStep * GridStep;
end;

Thus, if the magnitude of the difference between the anchor point and the absolute position calculated at the current time step is greater than the predetermined number of grid steps, then the anchor point is moved to a new anchor point, which is the closest grid position to the newly calculated absolute position. Note that the anchor point may affect the cursor position, but the cursor position does not affect the anchor point.

The anchor point can then be used to introduce bias to the cursor movement to correct the cursor position. If the current cursor position is more than a predefined number of grid steps (e.g., 6 grid steps or 300 pixels) away from the anchor point, then a position correction mode is engaged. If the current cursor position is less than a predefined number of grid steps (e.g., 1 grid steps or 50 pixels) away from the anchor point, then the position correction mode is disengaged. If the position correction mode is engaged, the cursor is moved towards the anchor point at each update time step with a pre-selected speed (e.g., 1/500 of a distance from the current cursor position to the anchor point).

The correction mode can be applied to horizontal and vertical axes separately or jointly. The following exemplary code fragment illustrates the algorithm that can be applied to the separate x coordinate. Similar code corrects the y coordinate.

if Abs(CursorPosition.x-AnchorPoint.x)>6*GridStep then XCorrectionMode:=True;

if Abs(CursorPosition.x-AnchorPoint.x)<GridStep then XCorrectionMode:=False;

if XCorrectionMode

then.x:=CursorPosition.x+(AnchorPoint.x-CursorPosition.x)/500;

That is, if the absolute difference between the cursor position and the anchor point is greater than a predetermined number of grid steps, then the cursor position is slowly brought closer to the anchor point.

Input received from a gyroscope moves the computer element, such as the cursor, independently of the grid correction algorithm. The grid correction algorithm can be executed at each update time step to perform the position correction.

A separate potential issue relates to head motion input devices, which is resetting the controlled element, such as a cursor, to center of vision. Some input devices, such as mice, are typically used in a space that is relatively smaller than the space traversed by the controlled element on the screen. For example, a user may move a mouse in a six inch by six inch area to control a cursor across a screen that is seventeen inches with the cursor to mouse motion scaled 1:1. When the user reaches the boundary of the mouse pad, the user simply lifts the mouse and moves the mouse to another area of the mouse pad. An analogous motion is not available with a head motion input device. This is particularly problematic, because the movement of the user's head is rather limited due to the fact that it is desirable for the user to keep his or her eyes comfortably trained on the screen. Also, once a user moves his or her head to control the element to the desired location or to a desired orientation, he or she may wish to move his or her head to a more comfortable position without controlling the element on the screen. In some embodiments, the system does not automatically center the computer element within the user's viewing frame.

One solution for the aforementioned problems is use of vector suppression or backtrack suppression. Vector suppression or backtrack suppression suppresses the components of the measurements that the device interprets as being head motion that corresponds to resetting the head location without moving the computer element to an undesired location or orientation. Referring to FIG. 3, a device for allowing for resetting the controlled element includes a gyroscope 205. The gyroscope sends velocity measurements to a fast motion detector 260 that controls the back motion suppressor 250. Both fast motion detector 260 and back motion suppressor 250 are implemented in software. If the velocity of the head movement is above a pre-determined threshold, the fast motion detector 260 enables the motion suppressor 250, which filters out any head movement opposite to the direction of the initial fast movement. Otherwise, the velocity measurements are sent to a converter 270, which converts the integrated measurements to a mouse-like input. The input is then sent to a computer in a form of relative change of the mouse cursor position. The fast motion detector 260 disables the motion suppressor 250 after a certain period of time (e.g., 500 milliseconds) or sooner if the head starts moving in the same direction as the initial fast motion. The fast motion detector 260, back motion suppressor 250, integrator 230 and converter 270 can be separate processing components or a single processing component.

When the user moves his or her head normally, these movements are understood to control the computer element, e.g., the cursor, to move the element to a new location. Rapid head movement, however, can indicate that the user desires to reset the head control without moving the cursor in the opposite direction. The gyroscope detects the increased velocity of this “reset” motion. The opposite motion just thereafter is suppressed. The suppression period can be set at any comfortable length of time that does not impede usefulness of the head motion device, such as one second, a half a second, a quarter of a second or a tenth of a second. In some devices, when the user moves his or her head rapidly in one direction and then moves his or her head in the opposite direction, the element being controlled, such as a cursor, is in a locked position allowing the user to re-adjust head position with respect to the screen. In some devices, the rapid movement is also suppressed from the control device output. Because the rapid movement indicates that some portion of the gyroscopically detected motion should be suppressed when used to form a control signal for inputting to the computer, the suppression is referred to as vector suppression or backtrack suppression.

The following exemplary code fragment illustrates an implementation of the backtrack suppression algorithm. The system has three states: BTOff, BTStart and BTKill. In the BTOff state, the system moves the mouse cursor based on the gyroscope input without any restrictions. If the magnitude of the gyroscope input exceeds a BTThreshold value the system switches to the BTStart state and saves the value of the gyroscope input vector. BTThreshold is a user-controlled parameter that defines a desired speed at which the backtrack suppression engages. In the BTStart mode the system detects when the head begins to move in the opposite direction in relation to the fast motion that triggered the backtrack suppression mode. The detection is based on the sign of the dot product of the current gyroscope input and the gyroscope input saved when the BTStart state was enabled. When the opposite movement is detected, the system switches to the BTKill state. In the BTKill state, the gyroscope input is ignored until either the head starts moving in the same direction as the motion that triggered the BTStart or after a certain time (e.g., 500 ms) elapses from the time that the BTKill mode was engaged. The following exemplary code fragment may be used for backtrack suppression.

```
    case BacktrackMode of
BTStart:
  if DMul(BacktrackMove, GyroMove) < 0 then
  begin
    BTStartTime:=GetTickCount;
    BacktrackMode:=BTKill;
  end;
BTKill:
  if (DMul(BacktrackMove, GyroMove) > 0) or
    (GetTickCount − BTStartTime > 500)
  then BacktrackMode:=BTOff;
      BTOff:
      if Mag(GyroMove) > BTThreshold then
      begin
        BacktrackMode:=BTStart;
        BacktrackMove:=GyroMove;
      end;
    end;
  if BackTrackMode=BTKill then GyroMove:=Vector(0,0);
```

A glide algorithm is an alternative to the backtrack suppression algorithm. Instead of stopping the mouse cursor when the user's head moves in the direction opposite to the initial fast move, the glide algorithm slows down or stops the mouse cursor when the user's head moves faster than a predetermined threshold. The following pseudocode demonstrates an implementation of the glide algorithm with non-linear (sinusoidal) gyroscope-to-mouse motion characteristic.

```
GlideVector:=Vector(GyroMove.z, GyroMove.y);
if Mag(GlideVector) <> 0 then
begin
  if LatchThreshold.Value = 0 then GlideAngle:=0
  else GlideAngle:=Mag(GlideVector)/LatchThreshold.Value*Pi/2;
  if GlideAngle > Pi then GlideVector:=Vector(0, 0)
  else GlideVector:= SMul(VNorm(GlideVector),
        LatchThreshold.Value * 2 / Pi * sin(GlideAngle));
end;
GyroMove.z:=GlideVector.x;
GyroMove.y:=GlideVector.y;
```

Microcontroller implementation of algorithms may optimize the calculations with fixed-point arithmetic.

The methods for suppressing a portion of the signals received from a sensor that detects motion or rotational orientation can be free of a signal filter. Filters can slow the conversion of orientation or movement sensing into input for a computing device. Therefore, systems that do not use a filter can be faster than systems that use filters.

In some embodiments, the user is able to dynamically engage and disengage the computer element control with specific actions or gestures. For example, a particular gesture or action may allow the user to temporarily move the computer element with the head motion. The actions may include pressing a button or clenching teeth. Teeth clenching can be detected with a biometric sensor, such as an EEG or EMG sensor, attached to the headset.

Camera angle control in games with first-person 3D perspective is normally achieved by using a mouse-like or joystick-like device. A direct gyroscope-based control of the camera angle with gyroscopes attached to the player's head works well with head-mounted displays. A small amount of drift does not negatively affect the user's experience greatly. However, the direct gyroscope control presents significant head-to-screen view alignment problems with regular fixed desktop or laptop monitors. Although the backtrack suppression and glide algorithms solve the head alignment problem, they may not feel natural to some users and may require some training for camera angle control.

An alternative method of changing the camera angle with head motion is joystick-like camera rotation control or joystick control mode. The joystick control mode uses gyroscope input to calculate the head deflection from the initial position. The camera angle or the mouse cursor position changes with a speed proportional to the current head deflection angle in the corresponding direction. Similar to the classic joystick control, the algorithm uses a predefined threshold called the dead zone for head deflection. If head deflection distance or percentage of an overall distance is below this threshold the camera or the mouse cursor do not move. Above the threshold, head deflection is translated into speed of change of the camera angle or the mouse cursor position. If the head is moved a small amount, the camera angle changes slowly and if the head is move a larger amount, the camera angle changes more quickly. In some embodiments, the threshold movement is based on a predetermined time period.

Although it has been noted that a head motion input device can be used to detect the pitch, roll and yaw of the user's head, it may be desirable to use only one or two of these motions as input. In some systems, it may be desirable to use the head motion input device in combination with one or more other input devices, which can provide greater flexibility and a method of input that is more intuitive for the user. In one exemplary head motion input device, the device enables the user to use head pitch and yaw to control the absolute head position of a character in an electronic game. The roll is rarely used and can be controlled with a device that acts in a joystick or mouse-type way, allowing for full 360 degree rotation of the head. In some devices, one, two or three gyroscopes provide the desired input, without requiring any correction from accelerometers, tilt sensors or magnetometers. For example, the signals produced by multiple gyroscopes may be integrated to produce raw position data or camera angle change data. In some embodiments, one three-axis gyroscope can be used to determine pitch, roll and yaw. In some embodiments, two gyroscopes, such as two two-axis gyroscopes, are used to determine pitch, roll and yaw. And in some embodiments, a single gyroscope is used to determine only two types of movement, such as pitch and yaw. The two types of measurements can be transformed into x and y coordinates, as described further herein. When more than one gyroscope is used, the gyroscopes can be positioned in mutually orthogonal directions to one another.

The head motion input system can be used in combination with a number of other user interface devices to extend or augment user input functionality. A regular mouse, keyboard, or any other device with buttons can serve as mouse button input for an inertial system that otherwise does not have similar functionality. In addition or alternatively, special gestures or actions such as side-to-side head motion or winking can be detected and used as the mouse button input in systems with head motion detection. Winking can be detected with an EEG or EMG sensors attached to the headset.

The head motion input system can be combined with a speech recognition system, such as the one included in the Windows Vista® operating system. Speech recognition systems lack convenient cursor positioning control. The head motion sensor system integrated into headphones with a microphone can form a user input system capable of controlling the cursor with head motion and providing the rest of the control by a speech interface, or sound recognition system, which can replace the mouse button and keyboard input. In some embodiments the headphones include earphones. Such a device allows the user to control all conventional elements of a computer interface without use his or her hands.

In some embodiments, the head motion input device has different types of processing and different parameters for vertical and horizontal axes of mouse cursor control as well as for pitch, yaw, and roll of the camera control. For example, the vertical mouse cursor motion can have lower sensitivity than the horizontal one. The backtrack suppression, glide, and joystick-like modes can be enabled selectively for only one axis. For example, the yaw control of the camera view may function in joystick-like mode to allow for a quick complete rotation while the pitch control is in non-joystick mode, because the pitch range of the game camera is naturally limited and does not require quick continuous rotation.

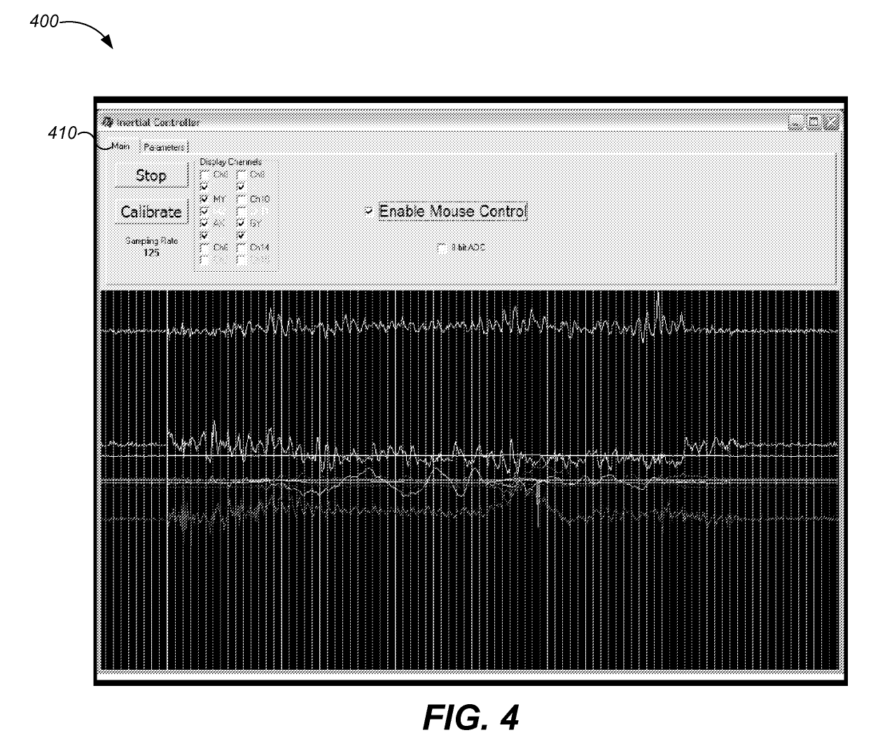

Referring to FIGS. 4 and 5, a graphical user interface (GUI) 400 shows an exemplary set of controls for the head motion input device. The controller can have information on tabbed pages, including a main page 410 and a parameters page 420. The main page 410 can show a main control panel, which can be used for one or more of the following actions—to start and stop communication with the device, initiate calibration or recalibration, enable or disable the mouse control, view the estimated sampling rate or to enable or disable the display of individual signal channels. The GUIs may display a plot of the signals in the lower part of the window.

The parameter page 420 can display controls and adjustments for various parameters, such as how the signals control input to the computer, which might otherwise be received as mouse input and which is therefore referred to as mouse input here. One or more of the following panels may be included on the parameter page 420. For example, an Application Program Interface (API) panel 430 can control how the system uses an API, such as Win32 API, to generate mouse events. The API can switch between relative and absolute mouse input. In the relative mode, the system simulates relative mouse motion sending the number of vertical and horizontal mouse steps from the current position to the mouse input. In the absolute mode, the system sends the changing absolute mouse position to the mouse input. The API panel 430 can also control the absolute mouse position scale. The larger the number, the faster the cursor moves in response to head movement. The absolute mouse coordinate system can have 65536×65536 resolution in Win32 API. This coordinate system is mapped onto the screen.

A gyroscope control panel 440 can adjust the way the system handles gyroscope signals. The sensitivity and deadzone adjust the general sensitivity of the mouse input to the gyroscope signals and define the minimum signal value that moves the mouse. The autocalibration option enables the system to automatically adjust the 0 level of the gyroscope output during periods when little or no head movement is detected. For specific games or applications, such as Tetris, an application specific control option enables a keyboard control simulation to control a specific version of the game or application with head movement. The latch threshold selects the head movement speed that engages the backtrack suppression mode if it is selected with the latch mode control for X and Y axis.

Separate X and Y panels 450, 460 can enable selection of how the system maps device input to the corresponding axes of cursor movement. X is the horizontal axis and Y is the vertical axis. The movement of the element on the screen or viewing angle shown on the screen, such as the camera or the cursor, can be controlled either by a gyroscope alone, by absolute position derived from the magnetic and/or gravity vectors, or by gyroscope with absolute position correction, that is, the gyroscope after correction from one or both of an accelerometer and a magnetometer. The cursor movement can be inverted and, in the case of a gyroscope-only control device, be put in backtrack suppression mode. Although the backtrack suppression mode can be used for any type of coordinate control device, the control panel application allows the user to enable it for gyroscope-only control.

Two additional X Absolute and Y Absolute panels 470, 480 allow the user to select the source of absolute positioning and adjust the absolute position sensitivity in mouse steps per radian. The options for absolute X control are combined magnetometer/accelerometer yaw, accelerometer only roll, magnetometer only yaw, and magnetometer only roll. The options for absolute Y control include combined magnetometer/accelerometer pitch, accelerometer only pitch, and magnetometer only pitch.

A head motion input device having any orientation sensor, that is, any single component that is described herein, such as a gyroscope, an accelerometer, a magnetometer, tilt sensor or any combination of these components, can be used to control a computer element, such as a cursor or a camera angle. When used in combination with other types of devices, such as sensors and electrodes in a headset, such as the headset described in U.S. Publication No. 2007-0225585, the orientation sensor can be used to control the behavior and appearance of an avatar in a game. The input device can control the direction of the camera angle and the object on which the avatar is focused when viewed from a first person perspective. Brainwave information or muscle movement detected by the same headset can control the facial expressions, or other features, of the avatar when viewed by another player. The other player may also be able to see the head movements controlled by the head motion input device.

The devices described herein convert measurements obtained by various components into a signal that is mouse-like so that the input device can be used by applications not specifically programmed for use with input devices other than mice, keyboards, or joysticks. However, the head motion input device may not be required to convert the measurements to mouse-like input. Software code on the computer or a microcontroller device attached to a computer, such as a dongle type receiver, that communicates with the input device can convert the signal into input that is useable by the software application. For example, a USB dongle with a Human Interface Device (HID) interface that mimics mouse, joystick, or keyboard signals can translate sensor input. Dongle firmware receives the sensor information and converts it to a form of user interface device input, such as relative mouse cursor motion, and passes it to the computer via the USB interface.

### Exemplary Device

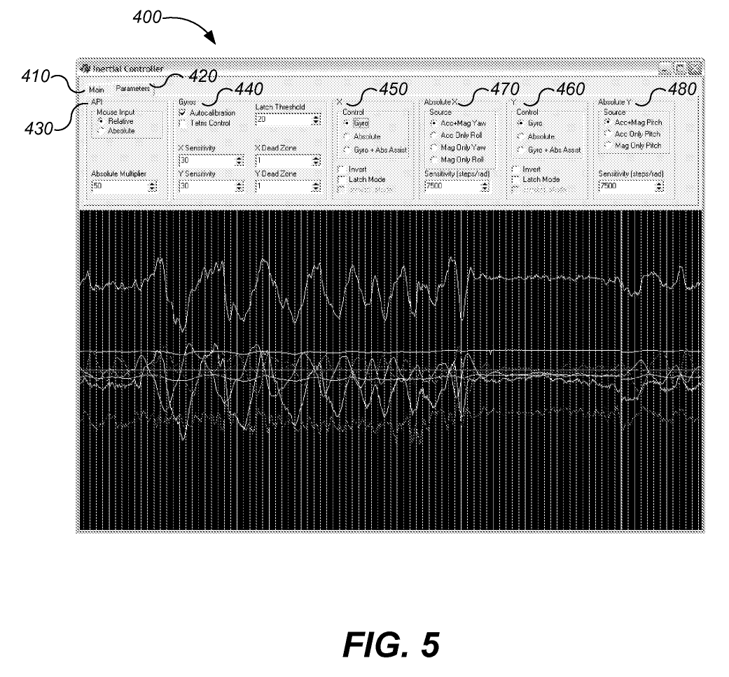

Referring to FIG. 6, a test head motion input device was formed that communicates with a digital board microcontroller. The device includes the following set of sensors, a receiver, and related firmware and software. The sensors include a 2-axis gyroscope, InvenSense IDG300 (InvenSense Inc., Santa Clara, Calif.), a 3-axis accelerometer, Freescale MMA7260Q (Freescale Semiconductor Inc., Austin, Tex.), and a 3-axis magnetometer, PNI MicroMag 3 (PNI Corporation, Santa Rosa, Calif.) with 3 mutually orthogonal PNI magnetoinductive sensors connected to PNI 11096 ASIC (also from PNI Corporation).

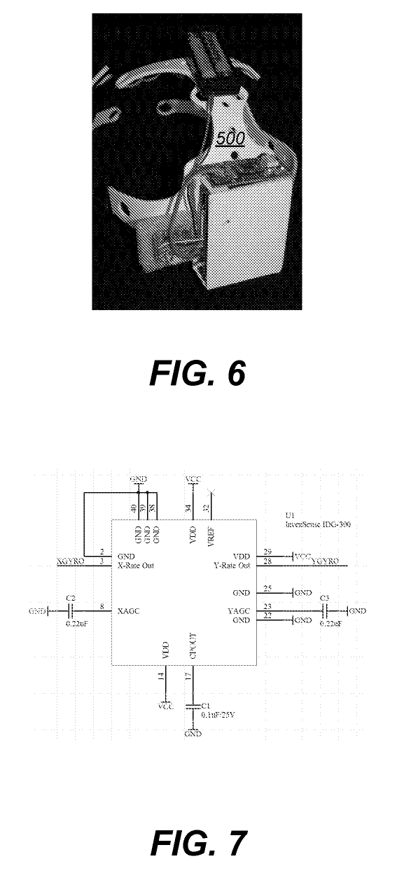

The gyroscope chip is mounted on a prototyping board with three capacitors for the change pump and the gain control, as shown in the schematic in FIG. 7. The outputs of the gyroscope chip are connected directly to either the EEG ADC or PIC ADC inputs. The three outputs of the 3-axis accelerometer chip mounted on the evaluation board are either connected to the EEG ADC or PIC ADC inputs. The 3-axis magnetometer that consists of 3 magnetic sensors and ASIC chip shares the SPI port with the EEG ADC clock generator chip.

The magnetometers communicate with the controller by Serial Peripheral Interface (SPI) interface. The gyros and accelerometers were tested with an EEG amplifier having a 24-bit analog to digital converter (ADC) per channel, as described further in U.S. Publication No. 2007-0225585, and with the digital board microcontroller 10-bit ADCs.

Test software was loaded onto a PC. The input device was placed into a headset 500, which was donned by a user. A suitable headset is shown in U.S. Publication No. 2007-0225585. Signals from the input device were used as mouse events to mimic mouse control, as well as keyboard control, for a Tetris game. Other software has been similarly tested, using the head motion device input to replace Windows XP mouse navigation, in applications including Quake version 3, Ultimate Tournament (UT) 2003, Torque FPS demo version 1.5, and Google™ Earth version 4.0.

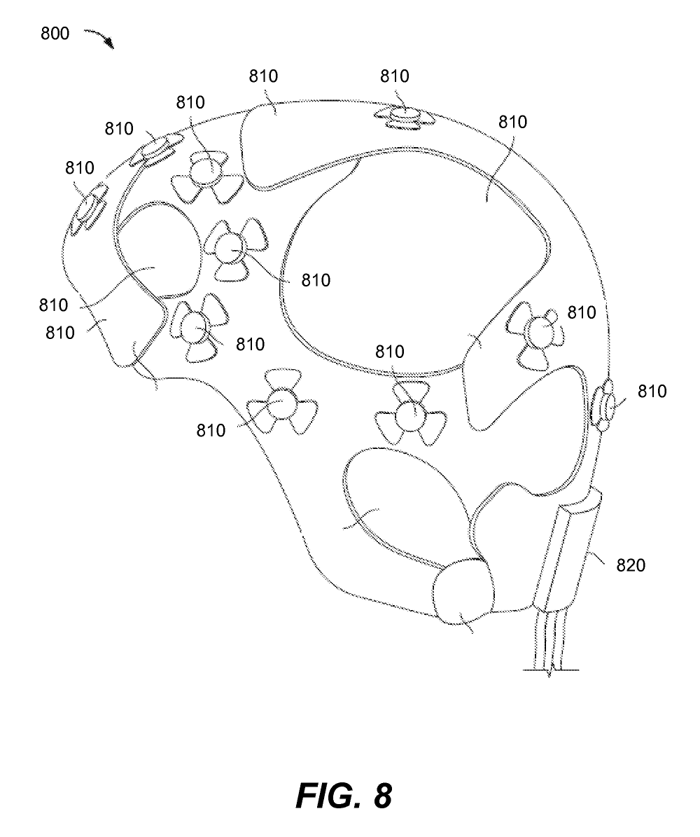

Referring to FIG. 8, in addition to the head motion input device, EEG, EMG or EKG sensors can be secured by a headset 800. The headset 800 can have the sensors 810 positioned in places that detect particular bioelectric signals, which can indicate information about the subject's facial expression (i.e., facial muscle movement), emotions or cognitive information. For example, teeth clenching or attempting to move a virtual object can be detected by the sensors, as described further in U.S. Publication No. 2007-0225585. Information obtained from the one or more sensors 810, such as four, five, six, seven, eight, nine, ten or more sensors, can be used in combination with head movement information obtained from a head motion input device 820.

Embodiments of the invention and all of the functional operations described in this specification can be implemented in electronic circuitry, or in computer software, firmware, or hardware, including the structural means disclosed in this specification and structural equivalents thereof, or in combinations of them. Embodiments of the invention can be implemented as one or more computer program products, i.e., one or more computer programs tangibly embodied in an information carrier, e.g., in a machine readable storage device or in a propagated signal, for execution by, or to control the operation of, data processing apparatus, e.g., a programmable processor, a computer, or multiple processors or computers. The computer can be a special application computer, such as a personal computer, gaming console or arcade machine. A computer program (also known as a program, software, software application, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

A number of embodiments of the invention have been described. Nevertheless, it will be understood that various modifications may be made without departing from the spirit and scope of the invention. For example, the head motion input device can also be used to detect head gestures such as left, right, up, down direction indications, a “yes” nod, a “no” shake and other such movements. The device can also provide input to machine learning algorithms that detect user actions such as “sitting down”, “standing up”, “lying down”, “walking”, “running” and similar actions that involve changing the head position. The device can also be used to detect head motion to assist in filtering out motion artifacts in systems that measure physiological signals such as EEG, EMG, EKG, skin and conductance. Accordingly, other embodiments are within the scope of the following claims.

What is claimed is:

1. An input device, comprising:
a headset configured to be worn on a user's head;
a sensor secured by the headset, wherein the sensor is configured to determine a movement of the headset; and
a processing component in electrical communication with the sensor and configured to suppress a portion of signals received from the sensor, wherein suppression is based on a speed, direction or distance of the movement of the headset;
wherein the sensor or processing component is configured to produce position information for controlling a computer element.

2. The input device of claim 1, wherein the processing component is configured to suppress a portion of the signals when the signals indicate the user's head is moving in a reverse motion following a faster forward motion.

3. The input device of claim 1, wherein the processing component is configured to suppress a portion of the signals when the signals indicate the user's head is moving faster than a threshold velocity.

4. The input device of claim 1, wherein the processing component is configured to suppress a portion of the signals when the signals indicate that the headset has moved less than a predefined threshold.

5. The input device of claim 1, wherein the sensor includes a gyroscope and a transmitter is in communication with the processing component and secured by the headset.

6. The input device of claim 5, further comprising a second gyroscope in communication with the transmitter and secured by the headset.

7. The input device of claim 1, wherein the processing component is configured to provide signals for inputting to a computer that is remote from the input device.

8. The input device of claim 1, wherein the sensor is a gyroscope and the device further comprises an accelerometer secured by the headset and in communication with the processing component.

9. The input device of claim 8, further comprising a magnetometer secured by the headset.

10. The input device of claim 9, wherein the processing component is further configured to use the signal received from the accelerometer and a signal received from the magnetometer to modify a signal generated by the processing component.

11. The input device of claim 10, wherein the processing component is configured to remove integration error propagated by the gyroscope.

12. The input device of claim 1, further comprising:
a microphone secured by the headset; and
a transmitter configured to transmit signals generated by the microphone and the sensor.

13. The input device of claim 1, further comprising:
a bioelectric sensor;
a transmitter configured to transmit signals generated by the bioelectric sensor and the sensor.

14. The input device of claim 1, wherein position changes are determined with respect to a coordinate system of the headset.

15. An input device, comprising:
a headset configured to be worn on a user's head;
a sensor secured by the headset, wherein the sensor is configured to determine a movement of the headset; and
a processing component in electrical communication with the sensor and configured to transform the movement of the headset into input for a computer which indicate a change in camera angle, wherein greater movement corresponds to a faster change in camera angle and lesser movement corresponds to a slower change in camera angle.

16. An input device, comprising:
a headset configured to be worn on a user's head;
a state sensor secured by the headset, wherein the state sensor is configured to determine a movement of the headset;
a biometric sensor secured by the headset, wherein the biometric sensor is configured to determine electric activity from the user's head; and
a processing component in electrical communication with the state sensor and the biometric sensor configured to create an input signal for a computing device from signals received from the state sensor and the biometric sensor.

17. The device of claim 16, wherein the processing component is configured to suppress a portion of the signals received from the state sensor, wherein suppression is based on a speed, direction or distance of movement of the headset.

18. A computer program product, encoded on a computer-readable medium, operable to cause a data processing apparatus to perform operations, comprising:
receiving a signal from a sensor, where the signal corresponds to movement of a user's head on which the sensor is located;
suppressing a portion of the signal from the sensor to create a modified signal, wherein the suppressing is based on a speed, direction or distance of movement of the user's head as indicated by the signal;
transforming the signal to input for a computer, wherein the input includes position information for controlling a computer element; and
sending the input to a computer.

19. The product of claim 18, wherein the product is further operable to cause a data processing apparatus to perform operations, comprising:
determining whether the user's head moves faster than a threshold velocity; and
suppressing a portion of the signal includes suppressing a portion of the signal received from the sensor after the fast head motion.

20. The product of claim 19, wherein the suppressed signal has a duration of less than about a half second.

21. The product of claim 18, wherein the product is further operable to cause a data processing apparatus to perform operations, comprising:
determining whether the user's head moves faster than a threshold velocity; and
suppressing a portion of the signal includes suppressing the signal received from the gyroscope that is in reverse of movement faster than the threshold velocity.

22. The product of claim 18, wherein the product is further operable to cause a data processing apparatus to perform operations, comprising:
determining whether the user's head moves beyond a threshold distance within a predetermined time period; and
suppressing a portion of the signal includes suppressing the signal received from the gyroscope if movement is not beyond the threshold distance.

23. The product of claim 18, wherein the input is sensor based input and the product is further operable to cause a data processing apparatus to perform operations, comprising:
receiving an audio signal;
corresponding the audio signal with an instruction to move a computer element to create an audio based input; and
sending the audio based input to the computer along with the sensor based input.

24. The product of claim 18, wherein the input is sensor based input and the product is further operable to cause a data processing apparatus to perform operations, comprising:
receiving a bioelectric signal;
transforming the bioelectric signal to a bioelectric based input for a computer; and
sending the bioelectric based input to the computer along with the sensor based input.

25. The product of claim 18, wherein the product is further operable to cause a data processing apparatus to perform operations, comprising:
receiving a correction signal from an accelerometer or a magnetometer; and
before sending the input, correcting error in the signal from the sensor with the correction signal.

26. The product of claim 25, wherein the error is integration error.

27. The product of claim 18, wherein the input is a first input and the product is further operable to cause a data processing apparatus to perform operations, comprising:
receiving a signal from a magnetometer; and
transforming the signal from the magnetometer to second input for a computer; and
sending the second input to the computer.

28. The product of claim 27, wherein the first input and the second input are combined into a single input signal.

29. The product of claim 18, wherein the input is a first input and the product is further operable to cause a data processing apparatus to perform operations, comprising:
receiving a signal from an accelerometer; and
transforming the signal from the accelerometer to second input for a computer; and
sending the second input to the computer.

30. A computer program product, encoded on a computer-readable medium, operable to cause a data processing apparatus to perform operations, comprising:
receiving input from a head motion input device, wherein the input corresponds to motion or orientation detected by a gyroscope, a magnetometer or a combination thereof,
corresponding the input to instructions to move a computer element a distance;
selecting an anchor point in a grid;
at a predetermined time, determining whether the distance is above or below a threshold; and
if the distance is below the threshold, not moving the computer element and if the distance is above the threshold, moving the computer element the distance.

31. The product of claim 30, wherein if the computer element is moved, the product is further operable to cause a data processing apparatus to perform operations, comprising selecting a new anchor point that is at a grid point closest to an absolute position corresponding to the instruction.

32. A computer program product, encoded on a computer-readable medium, operable to cause a data processing apparatus to perform operations, comprising:
receiving a signal from a sensor, where the signal corresponds to movement or orientation of a user's head on which the sensor is located;
suppressing a portion of the signal from the sensor to create a modified signal, wherein the suppressing is based on a speed, direction or distance of movement of the user's head as indicated by the signal;
transforming the signal to input for a computer; and
sending the input to a computer

33. A computer program product, encoded on a computer-readable medium, operable to cause a data processing apparatus to perform operations, comprising:
receiving a state signal from a state sensor, where the signal corresponds to movement or orientation of a user's head on which the state sensor is located;
receiving a biometric signal from a biometric sensor, wherein the biometric sensor is configured to determine electric activity from the user's head;
transforming the state signal and biometric signal to input for a computer; and
sending the input to a computer.

34. A computer program product, encoded on a computer-readable medium, operable to cause a data processing apparatus to perform operations, comprising:
receiving a signal from a sensor, where the signal corresponds to movement of a user's head on which the sensor is located;
transforming the signal to input for a computer, wherein the input includes camera angle information for controlling a computer element, wherein greater movement corresponds to faster camera angle change and lesser movement corresponds to slower camera angle change; and
sending the input to a computer.
